(19) United States
(12) Patent Application Publication
(10) Pub. No.: US 2022/0354150 A1
(43) Pub. Date: Nov. 10, 2022

(54) Composition for Krill-Based Protein Supplement

(71) Applicant: Paul Michael David Pierre, Davie, FL (US)

(72) Inventor: Paul Michael David Pierre, Davie, FL (US)

(21) Appl. No.: 17/685,246

(22) Filed: Mar. 2, 2022

Related U.S. Application Data
(60) Provisional application No. 63/185,260, filed on May 6, 2021.

(51) Int. Cl. A23L 17/10; A23L 33/19; A23L 29/00; A23L 33/105; A23L 33/16; A23L 33/18; A23L 33/115

(52) U.S. Cl. CPC A23L 17/10; A23L 33/19; A23L 29/06; A23L 33/105; A23L 33/16; A23L 33/18; A23L 33/115; A23V 2002/00

(57) ABSTRACT

A composition for krill-based protein supplement that provides a user with the necessary protein supply to repair and build muscle. The composition allows the body of a user to easily process and absorb the protein and nutrients as well. The composition includes a quantity of krill powder, a quantity of whey protein, and a quantity of digestive enzymes. The combination of the quantity of krill powder and the quantity of whey protein overcomes the natural response of blood thinning due to the quantity of krill powder and allows the composition to be consumed safely. The composition further includes a quantity of cocoa powder, a quantity of silicon dioxide, a quantity of stevia, and a quantity of sweetly stevia so that the composition may be thoroughly mixed with a beverage and still taste good.

The current application claims a priority to the U.S. provisional patent application Ser. No. 63/185,260 filed on May 6, 2021.

### FIELD OF THE INVENTION

The present invention generally relates to compositions for protein supplements. More specifically, the present invention is a composition for krill-based protein supplement.

### BACKGROUND OF THE INVENTION

Protein is critical to the human body to ensure that it stays healthy and can function the way it was built to. Protein is found in various organs all around the human body ranging from various leg muscles to each strand of hair. In order to turn fuel into energy and carry oxygen throughout the body protein is a vital necessity. Unfortunately, many individuals do not receive the proper amount of protein within their diet every day which limits their bodies from performing effectively and growing properly. In many situations with people who work out much of the time, such as athletes, they require even more protein within their diet to ensure that their muscles can rebuild properly and grow. One issue with needing more protein in one's diet is that overconsumption of protein can occur which mainly inhibits the effectiveness of the protein being absorbed into the body. This can result in the protein having less of an effect on muscle growth and in some instances can damage some parts of the body when there is too much protein. Many athletes move towards using protein supplements to ensure they have enough protein in their diets. However, not all protein is the same and many of these protein supplements are not as effective as getting protein naturally from various foods.

An objective of the present invention is to provide users with a protein supplement, to help individuals who want or need more protein in their diets. The present invention intends to provide users with a formula that can provide users with a protein supplement blend that enhances the body that can also be easily absorbed and utilized by the body. In order to accomplish that, a preferred embodiment of the present invention comprises krill powder and whey protein. Further, some of these ingredients create various other health benefits not necessarily related to protein. Thus, the present invention is a krill protein supplement blend that utilizes various ingredients to bring health benefits to the user and to ensure that the user's body can properly utilize the protein provided.

### BRIEF DESCRIPTION OF THE DRAWINGS

FIG. 1 is a block diagram of the present invention.

FIG. 2 is a block diagram illustrating the proportions of the present invention.

FIG. 3 is a block diagram of a preferred embodiment of the present invention.

FIG. 4 is a block diagram illustrating the proportions of the preferred embodiment of the present invention.

FIG. 5 is a block diagram of an alternate embodiment of the present invention.

FIG. 6 is a block diagram illustrating the proportions of the alternate embodiment of the present invention.

### DETAIL DESCRIPTIONS OF THE INVENTION

All illustrations of the drawings are for the purpose of describing selected versions of the present invention and are not intended to limit the scope of the present invention.

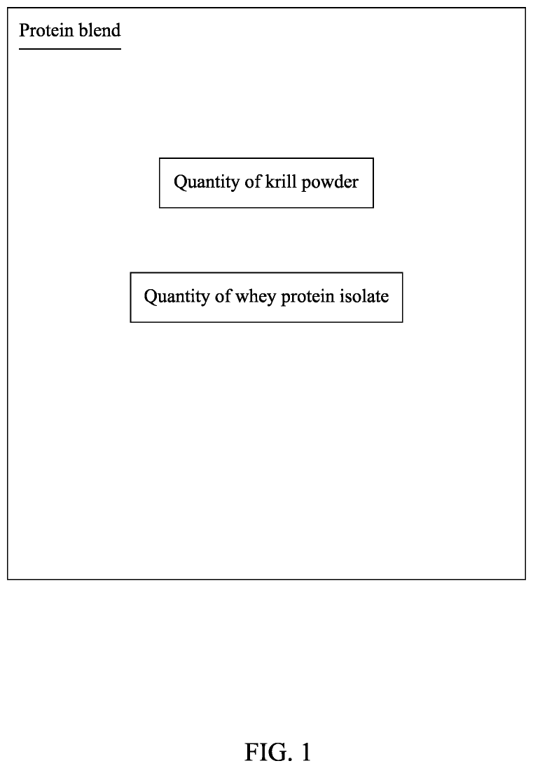

The present invention is a composition for krill-based protein supplement. The present invention ensures that a user receives adequate amounts of protein within throughout daily food consumption. The present invention utilizes krill protein in order for the body of a user to effectively and thoroughly absorb protein. Furthermore, the present invention facilitates muscle recovery from training and exercise. The composition of the krill-based protein supplement comprises a quantity of krill powder and a quantity of whey protein, as seen in FIG. 1. It is understood that a variety of other ingredients are included in the composition of the krill-based protein to improve mixability, taste, and digestibility of the present invention. Further embodiments of the present invention may be a composition that comprises a quantity of peptides in the quantity of krill powder. Furthermore, a first quantity of acids is infused with a second quantity of amino acids and a quantity of supplementary peptides from a separate animal-based source. In these further embodiments, the user receives amino acids from non-krill sources, as well as amino acids and peptides from krill.

The quantity of krill powder facilitates the natural absorption of the quantity of whey protein throughout the body of a user. The quantity of krill powder is high-quality protein that is an excellent source of amino acids, especially several essential amino acids. Furthermore, the quantity of krill powder allows the quantity of whey protein to be palatable instead of being bland or strange tasting. Conversely, the quantity of whey protein also improves the palatability of the quantity of krill powder as well. The quantity of krill powder also provides several nutrients.

The quantity of whey protein supplies the body of a user with adequate protein supply in order to boost muscle growth and enhance performance. The quantity of whey protein also facilitates digestion of proteins for smooth and efficient processing by the body of the user. Furthermore, the quantity of whey protein provides nutritional benefits such as limiting the amount of carbohydrates and fat entering the body while simultaneously ensuring the body receives the amino acids necessary to rebuild muscle. The quantity of whey protein consists of a quantity of phospholipids and a quantity of amino acids. The quantity of phospholipids allows for various nutrients to be easily absorbed by the body and utilized accordingly. The quantity of amino acids may be selected from a group consisting of a quantity of alanine, a quantity arginine, a quantity of aspartic acid, a quantity of cysteine, a quantity of glutamic acid, a quantity of glycine, a quantity of histidine, a quantity of isoleucine, a quantity of leucine, a quantity of lysine, a quantity of methionine, a quantity of phenylalanine, a quantity of proline, a quantity of serine, a quantity of threonine, a quantity of tryptophan, a quantity of tyrosine, a quantity of valine, and combinations thereof.

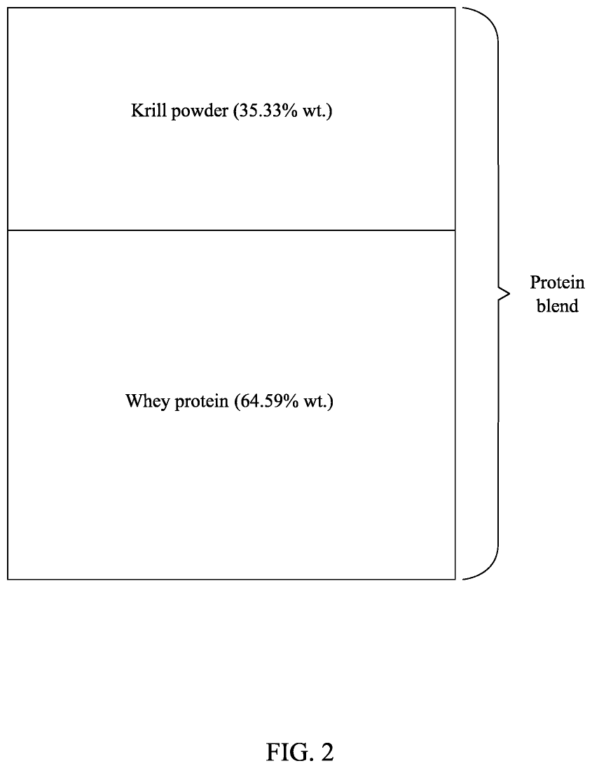

In order to receive the necessary amount of protein in order to effectively repair and build muscle and allow the body to process the necessary amount of protein, the quantity of krill protein power and the quantity of whey protein are heterogeneously mixed into a protein blend. The protein blend allows the quantity of krill powder to be consumed without the smell and taste of the quantity of krill powder being overwhelmingly unpleasant. A user may receive the benefits of the quantity of krill powder with the protein blend while maximizing the protein intake for the user with the quantity of whey protein. Moreover, the protein blend provides the nutritional value of both the quantity of krill protein powder and the quantity of whey protein simultaneously rather than multiple powdered blends. As seen FIG. 2, the quantity of krill powder is approximately 35.33 percentage by weight (wt.%) of the protein blend. Furthermore, the quantity of whey protein is approximately 64.59 wt.% of the protein blend. In reference to the aforementioned compositional proportions, the term “approximately” preferably means within an error range of up to ±0.005 wt.%.

In the preferred embodiment of the present invention, the quantity of alanine is approximately 4.16 wt.% of the quantity of whey protein. Furthermore, the quantity arginine is approximately 2.68 wt.% of the quantity of whey protein. Furthermore, the quantity of aspartic acid is approximately 10.69 wt.% of the quantity of whey protein. Furthermore, the quantity of cysteine is approximately 2.03 wt.% of the quantity of whey protein. Furthermore, the quantity of glutamic acid is approximately 17.79 wt.% of the quantity of whey protein. Furthermore, the quantity of glycine is approximately 1.81 wt.% of the quantity of whey protein. Furthermore, the quantity of histidine is approximately 1.76 wt.% of the quantity of whey protein. Furthermore, the quantity of isoleucine is approximately 5.75 wt.% of the quantity of whey protein. Furthermore, the quantity of leucine is approximately 10.69 wt.% of the quantity of whey protein. Furthermore, the quantity of lysine is approximately 9.36 wt.% of the quantity of whey protein. Furthermore, the quantity of methionine is approximately 2.10 wt.% of the quantity of whey protein. Furthermore, the quantity of phenylalanine is approximately 3.05 wt.% of the quantity of whey protein. Furthermore, the quantity of proline is approximately 5.71 wt.% of the quantity of whey protein. Furthermore, the quantity of serine is approximately 5.01 wt.% of the quantity of whey protein. Furthermore, the quantity of threonine is approximately 7.12 wt.% of the quantity of whey protein. Furthermore, the quantity of tryptophan is approximately 1.63 wt.% of the quantity of whey protein. Furthermore, the quantity of tyrosine is approximately 2.83 wt.% of the quantity of whey protein. Furthermore, the quantity of valine is approximately 5.79 wt.% of the quantity of whey protein. In reference to the aforementioned compositional proportions, the term “approximately” preferably means within an error range of up to ±0.005 wt.%.

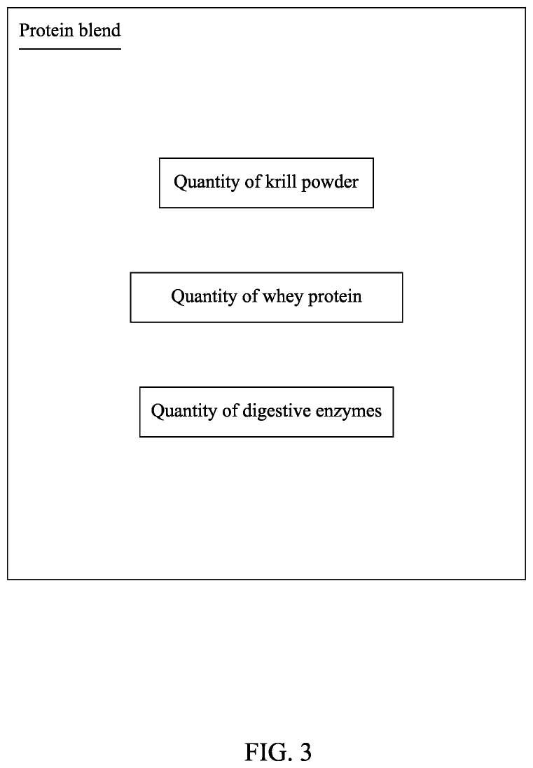

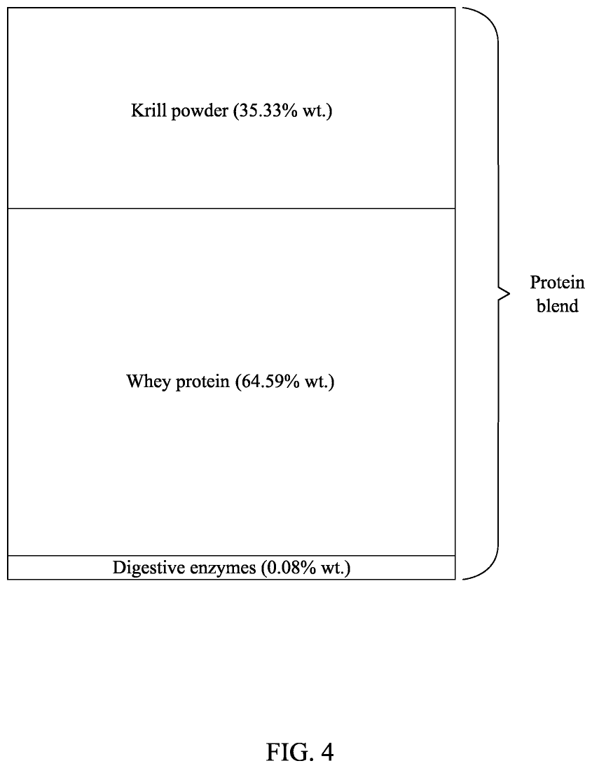

In order to aid the breakdown and absorption of the protein blend, the composition may further comprise a quantity of digestive enzymes, as seen in FIG. 3. The quantity of digestive enzymes aids the breakdown of lactose into glucose and galactose so the body of a user can produce energy that is needed after or before training or exercise, as well as for comfort, as opposed to digestive discomfort. In the preferred embodiment of the present invention, the quantity of digestive enzymes is lactase, however a variety of other digestive enzymes may be utilized for efficiency and safety. The quantity of digestive enzymes also increases nutrient absorption. Furthermore, the quantity of digestive enzymes compliments the taste and digestion of the present invention. In order to receive the necessary amount of protein in order to effectively repair and build muscle and allow the body to process the necessary amount of protein, the quantity of digestive enzymes is heterogeneously mixed into a protein blend. As seen in FIG. 4, the quantity of digestive enzymes is approximately 0.08 wt.% of the protein blend. In reference to the aforementioned compositional proportions, the term “approximately” preferably means within an error range of up to ±0.005 wt.%.

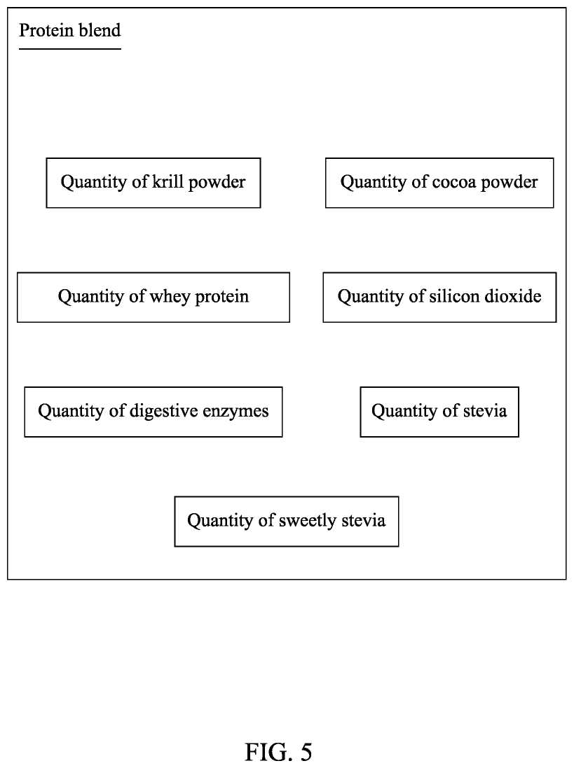

In order to define a flavor for the present invention and to overpower the natural taste of the quantity of krill powder and the quantity of whey protein, the preferred embodiment of composition of the krill-based protein supplement may further comprise a quantity of cocoa powder, a quantity of silicon dioxide, a quantity of stevia, and a quantity of sweetly stevia, as seen in FIG. 5. The quantity of cocoa powder defines a chocolate flavor for the present invention. In alternate embodiments of the present invention, it is understood that the quantity of cocoa powder is a quantity of flavoring powder which may be selected from a group consisting of a quantity of vanilla powder, a quantity of strawberry powder, and so on. The quantity of silicon dioxide is an additive that reduces or eliminates clumping. More specifically, the protein blend is evenly mixed because of the quantity of silicon dioxide. The quantity of stevia and the quantity of sweetly stevia, together, provide the present invention with the necessary level of sweetness to create a pleasurable taste.

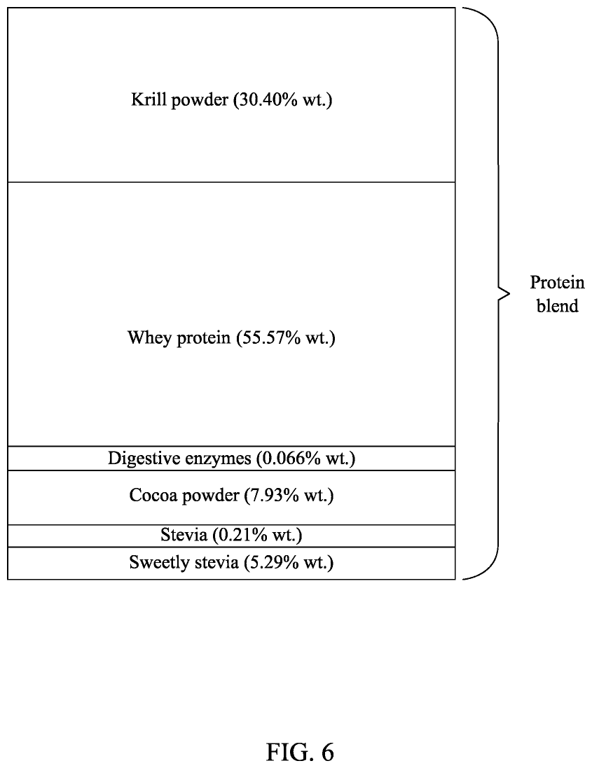

The protein blend is more appetizing and easier to consume as the quantity of cocoa powder, the quantity of silicon dioxide, the quantity of stevia, and the quantity of sweetly stevia are further heterogeneously mixed into the protein blend. In order to maintain the physical benefits of the protein powder while simultaneously being appetizing, the quantity of krill powder is approximately 30.40 wt.% of the protein blend, as seen in FIG. 6. Furthermore, the quantity of whey protein is approximately 55.57 wt.% of the protein blend. Furthermore, the quantity of cocoa powder is approximately 7.93 wt.% of the protein blend. Furthermore, the quantity of silicon dioxide is approximately 0.53 wt.% of the protein blend. Furthermore, the quantity of stevia is approximately 0.21 wt.% of the protein blend. Furthermore, the quantity of sweetly stevia is approximately 5.29 wt.% of the protein blend. In reference to the aforementioned compositional proportions, the term “approximately” preferably means within an error range of up to ±0.005 wt.%.

In order for the krill powder to effectively provide enough nutrients, the quantity of krill powder may include a quantity of peptides, a quantity of phospholipids, a quantity of moisture, a quantity of ash, a quantity of carbohydrates, a quantity of astaxanthin, or combinations thereof. Furthermore, the quantity of peptides is approximately 55% by volume (vol.%) to 65 vol.% of the quantity of krill powder at normal temperature and pressure (NTP). The quantity of phospholipids is approximately 25 vol.% to 30 vol.% of the quantity of krill powder at NTP. The quantity of moisture is less than 8 vol.% of the quantity of krill powder at NTP. The quantity of ash is approximately 4 vol.% to 8 vol.% of the quantity of krill powder at NTP. The quantity of carbohydrates is less than 4 vol.% of the quantity of krill powder at NTP. The quantity of astaxanthin is less than 1 vol.% of the quantity of krill powder at NTP. In reference to the aforementioned compositional proportions, the term “approximately” preferably means within an error range of up to ±0.5 vol.%.

Further embodiments of the present invention comprise a quantity of krill powder that also includes a quantity of Omega-3 fatty acids, and the quantity of phospholipids are bound by a quantity of astaxanthin, a quantity of eicosapentaenoic acid (EPA), and a quantity of docosahexaenoic acid (DHA). The quantity of Omega-3 fatty acids gives a user various protection from diseases such as obesity, diabetes, cardiovascular disease, cancer, and a variety of neurological diseases. In addition, the quantity of Omega-3 fatty acids supports the immune system of a user. Furthermore, the quantity of Omega-3 fatty acids stimulate anabolism and enhance the absorption of the quantity of whey protein. The quantity of EPA and the quantity of DHA are essential fatty acids that ensure the body of a user can regulate blood clotting and blood flow, which are essential to the inflammation process. More specifically, the quantity of krill powder in combination with both the quantity of whey protein and the quantity of digestive enzymes does not threaten blood thinning in the body of the user because of the quantity of EPA and DHA. The quantity of Omega-3 fatty acids is preferably approximately 10% of the quantity of krill powder. As the quantity of EPA and the quantity of DHA are not naturally occurring in the body of a user, the quantity of krill powder serves as an essential supply or EPA and DHA. The quantity of astaxanthin is a powerful antioxidant that aids to counteract various levels of oxidative stress, which in turn provides various health benefits such as limited damage of cells. Furthermore, the quantity of astaxanthin also provides a reddish tint for the protein blend and increases the shelf life of the product.

Although the invention has been explained in relation to its preferred embodiment, it is to be understood that many other possible modifications and variations can be made without departing from the spirit and scope of the invention as hereinafter claimed.

What is claimed is:

1. A composition for krill-based protein supplement comprising:
a quantity of krill powder;
a quantity of whey protein; and
the quantity of krill protein powder and the quantity of whey protein being heterogeneously mixed into a protein blend.

2. The composition for krill-based protein supplement claimed in claim 1 comprising:
the quantity of krill powder being approximately 35.33 percentage by weight (wt.%) of the protein blend.

3. The composition for krill-based protein supplement claimed in claim 1 comprising:
the quantity of whey protein being approximately 64.59 wt.% of the protein blend.

4. The composition for krill-based protein supplement claimed in claim 1 comprising:
a quantity of digestive enzymes;
the quantity of digestive enzymes being further heterogeneously mixed into the protein blend.

5. The composition for krill-based protein supplement claimed in claim 4 comprising:
the quantity of digestive enzymes being approximately 0.08 wt.% of the protein blend.

6. The composition for krill-based protein supplement claimed in claim 1 comprising:
a quantity of cocoa powder;
a quantity of silicon dioxide;
a quantity of stevia;
a quantity of sweetly stevia; and
the quantity of cocoa powder, the quantity of silicon dioxide, the quantity of stevia, and the quantity of sweetly stevia being further heterogeneously mixed into the protein blend.

7. The composition for krill-based protein supplement claimed in claim 6 comprising:
the quantity of krill powder being approximately 30.40 wt.% of the protein blend.

8. The composition for krill-based protein supplement claimed in claim 6 comprising:
the quantity of whey protein being approximately 55.57 wt.% of the protein blend.

9. The composition for krill-based protein supplement claimed in claim 6 comprising:
the quantity of cocoa powder being approximately 7.93 wt.% of the protein blend.

10. The composition for krill-based protein supplement claimed in claim 6 comprising:
the quantity of silicon dioxide being approximately 0.53 wt.% of the protein blend.

11. The composition for krill-based protein supplement claimed in claim 6 comprising:
the quantity of stevia being approximately 0.21 wt.% of the protein blend.

12. The composition for krill-based protein supplement claimed in claim 6 comprising:
the quantity of sweetly stevia being approximately 5.29 wt.% of the protein blend.

13. The composition for krill-based protein supplement claimed in claim 1 comprising, wherein the quantity of krill powder includes a quantity of peptides, a quantity of phospholipids, a quantity of moisture, a quantity of ash, a quantity of carbohydrates, a quantity of astaxanthin, or combinations thereof.

14. The composition for krill-based protein supplement claimed in claim 13 comprising:
the quantity of peptides being approximately 55% percentage by volume (vol.%) to 65 vol.% of the quantity of krill powder at normal temperature and pressure (NTP).

15. The composition for krill-based protein supplement claimed in claim 13 comprising:
the quantity of phospholipids being approximately 25 vol.% to 30 vol.% of the quantity of krill powder at NTP.

16. The composition for krill-based protein supplement claimed in claim 13 comprising:
the quantity of moisture being less than 8 vol.% of the quantity of krill powder at NTP.

17. The composition for krill-based protein supplement claimed in claim 13 comprising:
the quantity of ash being approximately 4 vol.% to 8 vol.% of the quantity of krill powder at NTP.

18. The composition for krill-based protein supplement claimed in claim 13 comprising:
the quantity of carbohydrates being less than 4 vol.% of the quantity of krill powder at NTP.

19. The composition for krill-based protein supplement claimed in claim 13 comprising:
the quantity of astaxanthin being less than 1 vol.% of the quantity of krill powder at NTP.
